(19) United States
(12) Patent Application Publication
(10) Pub. No.: US 2026/0254719 A1
(43) Pub. Date: Aug. 27, 2026

(54) SERVICE FOR GENERATING AN OVERALL HEALTH SCORE

(71) Applicant: Rothbright Inc., Edgewater, CO (US)

(72) Inventors: Daniel Harris PATTON, Edgewater, CO (US); Marcus Leonard FRYE, Las Vegas, NV (US); William Alexander JAY, Edgewater, CO (US)

(21) Appl. No.: 19/549,794

(22) Filed: Feb. 25, 2026

Related U.S. Application Data
(60) Provisional application No. 63/762,905, filed on Feb. 25, 2025.

(51) Int. Cl. H04L 41/082; H04L 67/53

(52) U.S. Cl. CPC H04L 41/082; H04L 67/53

(57) ABSTRACT

Systems and methods are disclosed for generating and increasing an overall health score of a digital trace associated with a network-accessible domain. Input parameters associated with the digital trace are accessed and associated with one or more fields of use based on the content or the architecture of the domain. Controlling criteria are selected from one or more repositories and used to generate a plurality of scores representing measured technical attributes of the digital trace. The plurality of scores can be aggregated into an overall health score associated with an operational tier. One or more deficient scores can be identified by comparing them with threshold values defined in a rubric, and, in response, an action addressing the deficient score can be generated. Updated overall health scores can also be generated.

### CROSS-REFERENCE TO RELATED APPLICATIONS

This application claims the benefit of and priority to U.S. Provisional Patent Application No. 63/762,905, filed Feb. 25, 2025, entitled “Service for Generating an Overall Health Score”, the entire contents of which are hereby incorporated by reference in their entirety.

### BACKGROUND

### 1. Technical Field

The present invention relates to scoring and improving digital domains and accounts.

### 2. Background and Relevant Art

Conventional systems for managing and analyzing digital footprints, such as accounts, website domains, and related data, may provide some level of insight or utility for users or entities seeking to monitor, assess, or control digital traces. While such systems may effectively gather or store this information, they often lack the flexibility or granularity needed to adapt to evolving digital environments or specific user needs. For example, conventional mechanisms may often focus on collecting static data or associating individual traces with a specific user. However, such approaches may provide challenges in situations where data must be analyzed dynamically across multiple platforms or correlated to uncover patterns.

Furthermore, conventional systems may present limitations in scalability and security. For instance, they may struggle to manage and process large datasets effectively, particularly when integrating diverse types of digital traces, such as digital accounts and domains. The lack of robust integration may lead to fragmented datasets, making it difficult to provide comprehensive and actionable insights. Similarly, security concerns may arise when sensitive information, such as account credentials or location data, is stored or processed without sufficient safeguards, increasing the risk of unauthorized access or misuse. As the landscape of digital activity continues to expand and evolve, and as regulations and requirements for digital traces continue to increase, there is a need for systems and methods that can address these shortcomings by providing more versatile, secure, and efficient tools for managing and analyzing digital traces. Accordingly, there are a number of difficulties in the art of generating overall health scores for digital traces that can be addressed.

Conventional computing environments also increasingly involve network-accessible domains, distributed service architectures, and multiple digital accounts that generate large volumes of machine-readable artifacts. Such artifacts may include configuration files, protocol-level settings, structured metadata, authentication parameters, executable modules, and infrastructure definitions. In certain environments, these artifacts are heterogeneous in format and are maintained across multiple platforms, hosting providers, or service interfaces.

In some existing technical implementations, digital trace information is collected or stored without a unified normalization framework capable of transforming heterogeneous machine-readable artifacts into a consistent internal schema. As a result, rule evaluation logic may be repeatedly implemented in format-specific ways, increasing computational overhead and reducing processing efficiency. Systems that evaluate heterogeneous artifacts without normalization may incur increased processor utilization, increased memory consumption, and reduced scalability when applied across large numbers of domains or accounts.

Additionally, in certain environments, evaluation of digital artifacts may involve applying large sets of validation rules without selective filtering based on contextual relevance. Where rule execution is not restricted to criteria applicable to a particular operational context, unnecessary rule evaluation may increase execution time and resource consumption. This can limit scalability and reduce the efficiency of automated validation processes.

Further, in some implementations, digital trace analysis is performed in an advisory or reporting capacity without direct modification of machine-readable configuration artifacts. Systems that generate static reports without automated remediation may require manual intervention to modify configuration files, protocol settings, or executable components. Manual remediation workflows may introduce latency, inconsistency, or configuration drift, particularly in distributed or dynamically deployed environments.

In addition, some computing environments lack mechanisms for dynamically adjusting runtime execution privileges or operational feature sets based on measured technical compliance states. Without a structured framework for associating measured technical attributes with execution privilege levels, systems may be unable to automatically enable or restrict functionality in response to changes in configuration or compliance posture.

As digital infrastructures continue to expand in scale and complexity, and as machine-readable standards evolve, there remains a need for technical architectures that (i) normalize heterogeneous digital traces into a unified schema, (ii) selectively apply machine-readable rule sets based on automatically determined classification states, (iii) automatically modify configuration or executable artifacts in response to detected deficiencies, and (iv) dynamically adjust runtime execution privileges based on measured technical compliance states.

### BRIEF SUMMARY

In some embodiments, the disclosed system improves computational efficiency and scalability by normalizing heterogeneous digital traces into a structured internal schema and selectively retrieving machine-readable controlling criteria based on automatically determined fields of use. The system further improves operational reliability by automatically modifying machine-readable configuration artifacts and dynamically adjusting runtime execution privileges in response to measured technical attributes, thereby reducing manual intervention and configuration inconsistency.

Accordingly, the present invention can comprise systems, methods, and apparatus configured to generate an overall health score and improve an overall health score for a digital trace. In particular, implementations of the present invention can additionally or alternatively comprise intelligent field of use determination, score generation and gathering, score deficiency monitoring, action generation, and automated enactment of actions, and overall health score generation/monitoring.

For example, in one implementation, a computer system comprises one or more processors and one or more hardware storage devices that store instructions that are executable by the one or more processors to cause the computer system to perform the following. The computer system can access input parameters associated with one or more digital traces of a user account. The one or more digital traces can include at least one network-accessible domain. The computer system can also associate the input parameters of the one or more digital traces with one or more fields of use. The computer system can also select controlling criteria from within one or more repositories associated with the one or more fields of use. The computer system may still further generate one or more scores associated with the selected controlling criteria. The one or more scores can include a numerical value that corresponds to a relationship between the one or more digital traces and the controlling criteria. The computer system may also identify a deficient score within the one or more scores by comparing the one or more scores with corresponding threshold values in a rubric embedded or associated with the controlling criteria and identifying if any of the one or more scores fall below the corresponding threshold values in the rubric. The computer system may also provide one or more actions for modifying any of the one or more scores that fall below the one or more scores corresponding threshold values in the rubric. The computer system may also generate an overall health score by aggregating the one or more scores and compiling the one or more actions. The computer system can also generate an updated overall health score after implementation of at least one of the one or more actions on the digital trace and unlock access to at least one feature, capability, or third-party opportunity in response to the updated overall health score satisfying a corresponding threshold level, thereby enabling execution of a previously restricted computer-implemented function based on the updated overall health score.

In another implementation, a computer-implemented method for increasing an overall health score of a digital trace can comprise accessing input parameters associated with one or more digital traces of a user account. The one or more digital traces can include at least one network-accessible domain. The method may include associating the input parameters with one or more fields of use determined based on a content or an architecture of the network-accessible domain. The method may also include selecting controlling criteria from within one or more repositories associated with the determined one or more fields of use. The method may further include generating a plurality of scores corresponding to the controlling criteria, each score representing a measured technical attribute of the digital trace. The method may still further include generating an overall health score containing the plurality of scores. The overall health score can be associated with a first operational tier. The method can also include identifying at least one deficient score by comparing the plurality of scores to corresponding threshold values defined in a rubric associated with the controlling criteria. The method may further include automatically updating, without user intervention, the content or the architecture of the digital trace in response to the at least one deficient score. The method may still further include generating an updated overall health score after the automatic updating of the digital trace. The updated overall health score can be associated with a second operational tier.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not, therefore to be considered to be limiting in its scope, the invention will be described and explained with additional specificity and detail through the use of the accompanying drawings in which:

FIG. 1 illustrates a computing architecture of the present disclosure;

FIG. 2 illustrates digital traces and input parameters of the present disclosure;

FIG. 3 illustrates a repository of the present disclosure;

FIG. 4 illustrates a score generation process of the present disclosure;

FIG. 5 illustrates a process of gathering input parameters of the present disclosure;

FIG. 6 illustrates a feedback loop of the present disclosure;

FIG. 7 illustrates a process of unlocking features of the present disclosure;

FIG. 8 illustrates a flowchart method of generating an overall health score of the present disclosure;

FIG. 9 illustrates another flowchart method of generating an overall health score of the present disclosure; and

FIG. 10 illustrates a computer system of the present disclosure.

### DETAILED DESCRIPTION

The disclosed embodiments extend to the generation of an overall health score (i.e., a machine state representation used to control system configuration and execution privileges) of a user’s digital trace. That is, the disclosed embodiments relate to automated technical compliance validation and configuration control systems for network-accessible digital domains. The embodiments can further include the optimization of the generated overall health score through actions provided with the generated overall health score. The present disclosure describes systems that can score, optimize, adapt, and grow digital traces, such as domains. This scoring architecture can provide users with advertisement contracts and opportunities, policy or regulatory adherence and guidance, financing plans of action, partnership opportunities, and business growth pathways. For example, users who implement the systems of the present disclosure can be provided a detailed view of the health or presence of their domains, as well as an executable plan of action to change and adapt portions of their domains to achieve specific business objectives, adhere to regulations, or meet success markers.

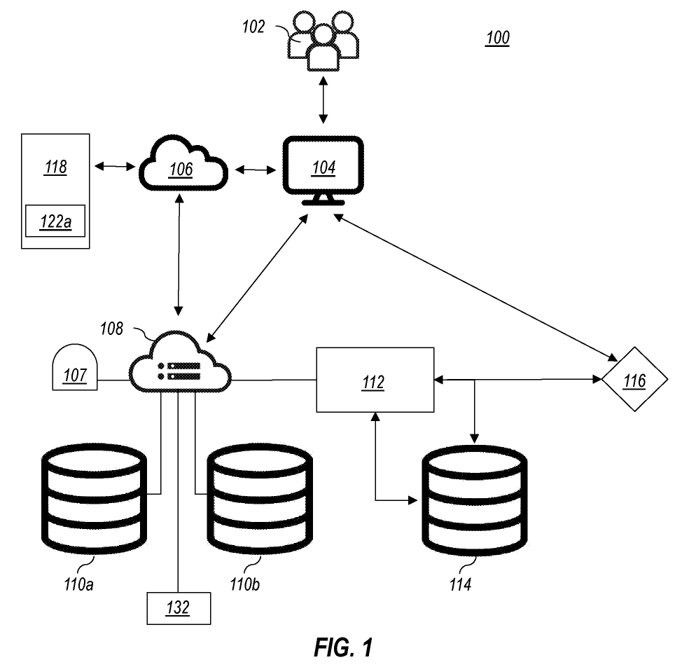

FIG. 1 illustrates a computing architecture 100 configured to generate domain or digital trace health scores. As used herein, a digital trace can be any number of digital identifiers, identities, accounts, locations, assets, or similar digital markers of an individual or business entity (e.g., websites, social media accounts, user accounts, etc.). Computing architecture 100 can be configured to access information from a digital trace 104, a user 102, and third-party sources 118 to analyze and produce an overall health score 116 that can provide a high-level look into the effectiveness, efficiency, and fiscal opportunities of digital trace 104. Digital trace 104 can be connected to a network 106. In some implementations, network 106 may include, but is not limited to, a local area network (LAN), a wide area network (WAN), a cellular network, a satellite network, or the Internet. Digital trace 104 can be directly connected to server 108 or connected to server 108 through network 106.

Digital traces may include, without limitation: domain name system (DNS) records; web server configuration files; transport layer security (TLS) certificate metadata; structured data embedded in markup; API configuration settings; source code artifacts; executable binaries; platform-specific metadata; access control lists; account-level configuration parameters; and machine-readable regulatory disclosures.

These digital traces may be retrieved through automated crawlers, API connectors, protocol-level queries, authenticated service integrations, or direct configuration file access. Because such traces are heterogeneous in format and structure, a normalization engine can convert the ingested artifacts into a unified internal representation using a normalized data model.

In some embodiments, the system employs a normalized data schema that maps heterogeneous digital trace attributes into structured records comprising: trace identifier; trace type classification; source platform; extracted technical attributes; timestamp metadata; version metadata; associated field-of-use classification; and compliance state indicators.

The normalized schema may be implemented as: a relational database schema; a graph-based data structure; a document-oriented data model; or a hybrid indexed data structure. By transforming heterogeneous source data into a unified internal schema, the system enables consistent application of controlling criteria across multiple trace types and platforms. This normalization improves computational efficiency by eliminating repeated format-specific evaluation logic and enabling rule execution against a standardized attribute set.

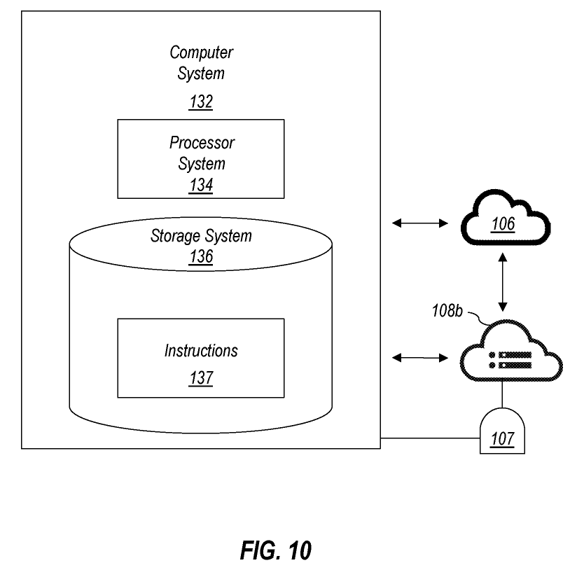

FIG. 1 illustrates that server 108 can be operatively connected to or capable of supporting agent 107. Server 108 may comprise a computing device or system that can be implemented as a physical hardware-based server, a virtual server, or a cloud-based server. Server 108 may include one or more processors, memory modules, and storage devices configured to execute, store, and manage data or software applications. In some implementations, server 108 may reside in a data center, on premises at a user’s location, or as part of a distributed cloud infrastructure. Server 108 may leverage virtualization technologies to operate within a cloud-based environment, enabling scalability, remote access, and dynamic resource allocation. Alternatively, server 108 may be implemented as a standalone physical machine with dedicated hardware resources such as computer system 132. FIG. 10 provides further details of a computer system 132 that can implement the computing architecture 100 of FIG. 1. Server 108 may communicate with other devices or systems through various communication protocols, such as Transmission Control Protocol/Internet Protocol (TCP/IP), Hypertext Transfer Protocol (HTTP), or secure Application Programming Interfaces (API). Server 108 may provide functions such as data processing, storage, authentication, or task orchestration.

As shown in FIG. 1, agent 107 may comprise an intelligent digital program, such as a large language model (LLM), artificial intelligence (AI) system, or similar machine learning (ML)-based system configured to execute computer commands, perform contextual analyses, process natural language inputs, generate outputs, and carry out complex computational tasks. Agent 107 may leverage one or more neural networks, decision trees, or other AI architectures to interpret and respond to user inputs, automate processes, and execute instructions based on programmed algorithms or dynamic learning models. Additionally, agent 107 may integrate capabilities for analyzing structured and unstructured data, interfacing with external systems or databases, and dynamically adapting responses or actions based on real-time inputs or learned patterns. This intelligent system may reside on a local computing device, a remote server, or a distributed cloud network and may interact with other software applications or hardware components through APIs or other communication protocols.

Addition models can be used as well. For instance, any type of small language model (SML), masked language model (MLM) or other model variants, as well as LLMs can be used. Additionally, action language models can be used and agentic models can be used.

FIG. 1 shows server 108 having one or more repositories 110, such as repository 110a and repository 110b. Repositories 110 can each be a dedicated data set (or a plurality of data sets) that is a compiled set of one or more controlling criteria, such as controlling criteria 119(a-c), seen in FIG. 3, in similar fields of use. For example, repository 110a can be a repository that has a field of use for health care. This could mean that all controlling criteria within repository 110a are directly or tangentially related to healthcare-focused objectives such as compliance with the Americans with Disabilities Act (ADA) and similar regulations. In another implementation, a repository may have an even more focused field of use, such as only having controlling criteria regarding information about a singular or specific regulatory act. More details regarding the controlling criteria can be found in the discussion in FIG. 3.

FIG. 1 shows that server 108 and agent 107 can be connected to or capable of executing process 112. Process 112 can include gathering, generating, planning, explaining, and/or similarly executing actions associated with generating an overall health score 116. As used herein, an ‘overall health score’ may comprise a numerical value, a categorical designation, an operational tier, a structured data object containing a plurality of sub-scores, or any combination thereof, and may further be associated with a compiled set of actions, recommendations, or executable plans. In at least one embodiment, process 112 may include evaluating machine-based discoverability, artificial intelligence visibility, and large language model interpretability associated with the digital trace. This may include analyzing how the digital trace is crawled, indexed, interpreted, or surfaced within AI-based discovery systems, automated answer engines, or large language model environments. For example, process 112 may search for an LLM.txt or similar subfile or machine-readable instruction within the codebase of a digital trace.

As shown in FIG. 1, rubric 114 can be operatively connected with process 112. Rubric 114 can comprise one or more threshold score values, such as threshold scores 124(a-c) seen in FIG. 4, that can be compared with any generated or gathered score to indicate what a score means (i.e., providing a context that allows agent 107 to prepare actions that a user may take). Thus, these threshold values allow agent 107 to determine whether a score indicates a deficient, acceptable, or optimized condition. In other words, rubric 114 provides meaning to any scores generated or gathered by agent 107 by allowing the scores, such as scores 120(a-c) in FIG. 3 and score 122a, to have a contextual value. The generated scores can be numerical scores that highlight or illustrate a relationship between the digital trace and the controlling criteria (e.g., how closely the digital trace meets the requirements of the controlling criteria).

In some embodiments, process 112 may include applying weighting or prioritization logic to the one or more generated or gathered scores. Such weighting may be based on a field of use, a business objective, a user preference, a policy or regulatory context, or a deployment environment associated with the digital trace. In this manner, identical scores may contribute differently to the overall health score 116 depending on contextual factors determined by agent 107 or provided by user 102.

For example, in addition to traditional performance, compliance, or user-facing metrics, rubric 114 may include threshold values for automated system readiness, machine-based interpretation, and artificial intelligence interaction with the digital trace. Such threshold values may be used to evaluate how effectively the digital trace can be accessed, understood, utilized, and acted upon by automated agents, artificial intelligence systems, and large language model environments. In at least one embodiment, these threshold values may relate to factors including, but not limited to, the presence, structure, and quality of AI-readable instruction files; the consistency, accuracy, and completeness of machine-consumable metadata; the organization and accessibility of underlying file directories; and the logical coherence of content as interpreted by automated systems.

In addition to traditional performance metrics and artificial intelligence-related evaluations, rubric 114 may include threshold values associated with a wide variety of operational, technical, regulatory, and commercial characteristics of a digital trace. Thus, rubric 114 may include threshold values for technical performance characteristics, such as page load times, uptime reliability, error rates, latency across geographic regions, and responsiveness under varying traffic conditions. Rubric 114 may further include threshold values associated with security and risk posture, including the presence or absence of encryption, certificate validity, authentication mechanisms, vulnerability exposure, access control configurations, and adherence to recognized cybersecurity practices. In some embodiments, rubric 114 may include threshold values for regulatory or compliance alignment, including accessibility requirements, privacy disclosures, data-handling practices, jurisdictional compliance markers, and conformity with industry-specific regulations.

Rubric 114 may also include threshold values related to content completeness and consistency, including accuracy of contact information, alignment of branding across platforms, completeness of disclosures, consistency of messaging, and freshness of published materials. In at least one embodiment, rubric 114 may include threshold values associated with commercial readiness or monetization potential, including suitability for advertising platforms, integration readiness for payment systems, eligibility for partnership programs, and alignment with third-party service requirements. Rubric 114 may further include threshold values related to user experience and engagement, including navigation clarity, interaction depth, bounce rates, accessibility of key functions, and usability across devices. Additionally, rubric 114 may include threshold values associated with data interoperability and integration readiness, including availability of application programming interfaces, data export capabilities, compatibility with external platforms, and support for standardized data formats.

In this manner, rubric 114 can provide contextual meaning not only for human-facing scores but also for machine-facing readiness, allowing agent 107 to generate actions that improve the digital trace’s suitability for automated discovery, interpretation, interaction, and utilization across a plurality of systems.

As shown in FIG. 1, third-party source 118 can be accessed by agent 107. In one example, third-party source 118 can be a website that provides a user with a score 122a, such as a website speed score. In such an example, agent 107 can dynamically communicate with user 102 or intelligently create an API to create an account or otherwise fully engage with third-party source 118. This communication with user 102 or dynamic API creation allows agent 107 to obtain a score 122a from third-party source 118. How agent 107 can generate scores itself is further detailed in the description of FIG. 3.

Agent 107 may also automatically evaluate changes in one or more scores over time. This may include identifying trends, rates of improvement, degradation patterns, or stability of individual scores or the overall health score 116. Such temporal evaluations may be used to generate additional actions, adjust threshold interpretations, or provide predictive insights regarding future health states of the digital trace.

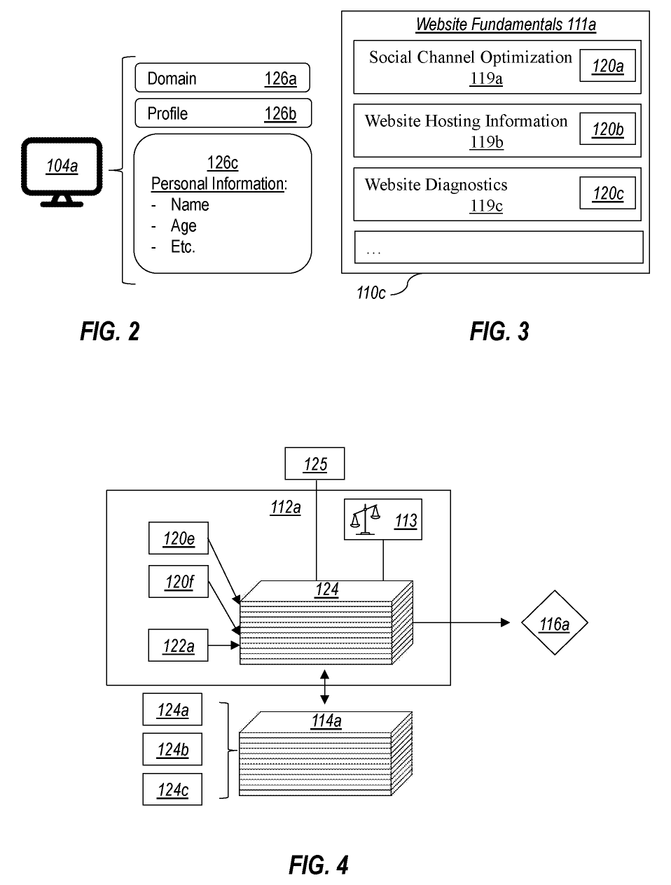

FIG. 2 illustrates digital traces 104a that can comprise input parameters 126(a-c). As shown, input parameters 126(a-c) can be a website domain address, input parameter 126a, profile information, input parameter 126b, and various user personal information such as name and age, input parameter 126c. Thus, input parameters can comprise, but are not limited to, different criteria such as login information, credentials, business information, financial information, and any other similar type of data that allows agent 107 to access a digital trace and parse through the digital trace to generate or obtain scores. In at least one embodiment, input parameters 126 may be associated with a plurality of digital traces. Agent 107 may thus compile, correlate, or distinguish input parameters across multiple digital traces to generate composite scores, comparative evaluations, or consolidated overall health scores. This is advantageous for an end user as their entire digital footprint may be monitored, improved, overhauled, etc., through the systems described herein, in a cohesive and comprehensive manner.

FIG. 3 illustrates a repository 110c. Repository 110c can have a field of use 111a that is based on or oriented towards basic website fundamentals. As used herein, a field of use may refer to a contextual classification, operational domain, industry category, regulatory environment, technical focus area, or objective-oriented grouping associated with a digital trace. A field of use for a digital trace may be determined based on one or more input parameters, the digital trace's characteristics, observed content associated with the digital trace, the digital trace's system behavior, user-provided objectives, or inferred operational context surrounding the digital trace. A field of use may also be explicitly specified by a user. A digital trace may be associated with a single field of use or with multiple fields of use concurrently. In such embodiments, agent 107 may select controlling criteria from multiple repositories that are associated with the plurality of fields of use, weigh controlling criteria differently based on field relevance, or dynamically adjust scoring based on interactions between fields of use. In situations where multiple fields of use apply to a single digital trace, agent 107 may resolve conflicts between controlling criteria by prioritizing fields of use based on regulatory risk, business objective, system confidence, or predefined hierarchy rules.

For example, a digital trace associated with a small business website may be determined to have a field of use related to basic website fundamentals based on observed characteristics such as page structure, hosting configuration, and publicly accessible content. In such an example, agent 107 may select repository 110c and apply controlling criteria related to website diagnostics, hosting information, and social channel optimization.

In another example, the same digital trace may additionally be associated with a regulatory compliance field of use based on the presence of accessibility-related content, privacy disclosures, or jurisdictional indicators. In this case, agent 107 may select controlling criteria from both repository 110c and an additional repository associated with regulatory compliance and may weigh the respective controlling criteria differently when generating scores and the overall health score.

A field of use may thus be used to organize, select, or prioritize controlling criteria within one or more repositories. Accordingly, field of use 111a can dictate the types and topics of controlling criteria 119(a-c) found within the data sets of repository 110c. For example, the field of use 111a can include the controlling criteria 119(a-c), social channel optimization, website hosting information, and website diagnostics, respectively.

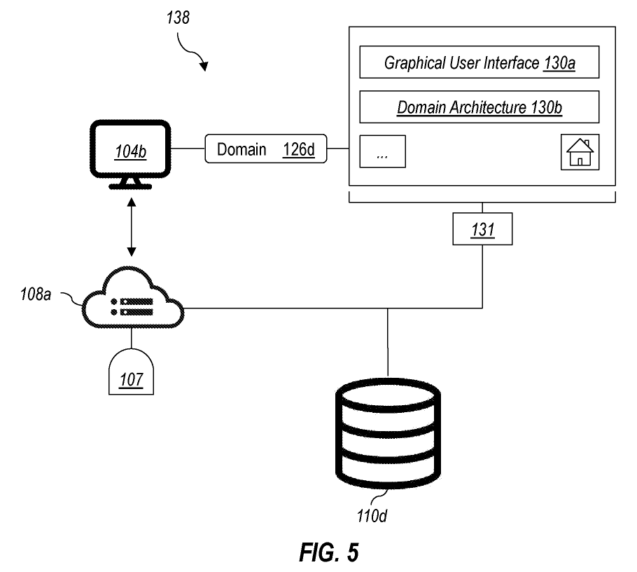

FIG. 3 shows controlling criteria 119a, regarding social channel optimization, which can be one or more data sets that outline the relevant information needed and the methods needed to generate a score 120a. In one embodiment, where the controlling criteria are social channel optimization, the relevant data and information can include the number of active social media profiles, the frequency of posts or updates, and the engagement rate, and counts for likes, shares, and comments relative to the follower count. Additionally, audience size and the consistency of branding across social profiles, such as logos, colors, and tone, could be used to indicate the level of professionalism and coherence in social media strategies. Agent 107 can review, crawl, or investigate a digital trace based on input information gathered by a user or through API creation and intelligent data-gathering techniques (e.g., as will be shown in FIG. 5) and use the gathered information to prepare a score, such as score 120a, for any given controlling criteria, such as controlling criteria 119a. Controlling criteria 119a can include any number of requirements, regulations, or similar traits or characteristics that could be applied to a digital trace.

Agent 107 may have access to controlling criteria 119a, and agent 107 may be configured to generate scores by utilizing advanced algorithms, statistical methods, and machine learning techniques. Agent 107 may process structured and unstructured data inputs, identify relevant patterns, and apply predefined or dynamically generated scoring models to evaluate specific metrics. Scores 120, such as scores 120(a-c), may represent a wide range of outputs, such as ranking relevance, measuring performance, predicting outcomes, or assessing compliance.

In at least one embodiment, repository 110c can include rubric and threshold score values within its own datasets, allowing agent 107 to both generate a score 120a and provide the meaning/context of that score without the need for a rubric 114 (see FIG. 1). Thus, rubric 114 may be implemented as a standalone component, embedded within a repository, or distributed across repositories.

FIG. 4 illustrates process 112a and an overall health score 116a. As previously discussed, agent 107 can generate scores, such as score 120(e-f), and gather scores, such as score 122a, that reflect a digital trace’s (such as digital trace 104 in FIG. 1) compliance with controlling criteria, such as controlling criteria 119(a-c). In generating scores 120(e-f), agent 107 may analyze data obtained from the digital trace, input parameters provided by a user, information discovered through automated crawling or interrogation of the digital trace, and data obtained from one or more third-party sources. Score generation may be based on quantitative measurements, qualitative assessments, rule-based evaluations, heuristic analysis, or combinations thereof. Agent 107 may further generate confidence indicators, normalization factors, or weighting inputs associated with one or more scores to account for data availability, reliability, or contextual relevance at the time of evaluation.

Agent 107 can then compile one or more scores, e.g., scores 120(e-f) and 122a. Compilation of scores may include organizing, normalizing, or aligning scores generated under different control criteria or repositories to enable meaningful comparison. Once compiled, scores 120e, 120f, and 122a can be compared with the corresponding threshold scores 124(a-c) of rubric 114a. Such comparisons may be performed individually for each score and may further consider contextual factors such as the field of use, a business objective, or data reliability. Based on the comparison of scores 120e, 120f, and 122a with the corresponding threshold scores 124a, 124b, and 124c, agent 107 can provide an overall health score 116a.

As shown in FIG. 4, the overall health score of 116a can be a singular aggregate score, or it can be a grouping of one or more scores and a compiled set of one or more actions that can be provided to a user. The aggregate score can be generated by a differential weighing process 113, where agent 107 selectively applies or generates weights for each score (120e, 120f, and 122a) based on the digital trace’s field of use and business objective 125. Business objective 125 can be determined automatically by agent 107 through intelligent field of use determination and data gathering, as illustrated in FIG. 5, or provided as an explicit input by user 102. For example, a user may have a desire to optimize a digital trace for increased advertising revenue, regulatory compliance, brand visibility, or conversion performance. Here, the business objective 125 may be provided as an input variable that allows agent 107 to dynamically adjust the differential weighing process 113 applied to generated and gathered scores associated with the user's desire. Through this process, agent 107 can assign increased or decreased priority to individual scores when generating the overall health score 116a, based on each score’s relevance or contribution to the selected business objective 125 or an alternative evaluation marker.

In some embodiments, differential weighing includes assigning numerical weight coefficients to individual scores prior to aggregation. The weight coefficients may be stored within a weighting matrix associated with a selected business objective. The embodiments can multiply each individual score by its corresponding weight coefficient and compute a weighted aggregate using linear aggregation, hierarchical aggregation, or threshold-conditioned scoring logic. The weighting matrix may be dynamically selected based on user-provided objectives or automatically inferred objectives determined by the field-of-use determination engine. Weight coefficients may be adjusted over time based on historical performance trends, predicted impact, or updated repository criteria.

Exemplary examples of a business objective 125 can include, but are not limited to one or more objectives, including (1) increasing advertising revenue or advertiser eligibility, (2) improving organic search visibility or ranking across traditional search engines or AI-driven discovery platforms, (3) optimizing the visibility, interpretability, or retrievability of a digital trace by large language models or AI-based search systems, (4) qualifying a digital trace for third-party partnerships, sponsorships, or platform participation, (5) increasing user engagement, retention, or conversion rates associated with the digital trace, (6) improving technical performance metrics such as loading speed, uptime, responsiveness, or device compatibility, (7) achieving, maintaining, or demonstrating compliance with regulatory, legal, accessibility, or industry-specific requirements, (8) reducing operational risk, security vulnerabilities, or exposure to penalties imposed by third-party services or platforms, (9) improving brand consistency, reputation, or trust indicators across one or more digital channels, (10) preparing a digital trace for monetization, acquisition, financing, or valuation analysis, (11) aligning a digital trace with a target market, geographic region, or demographic audience, (12) optimizing content structure, metadata, or underlying architecture for automated crawling, indexing, or agent-based interaction, (13) increasing interoperability with third-party systems, application programming interfaces, or automated agents, (14) prioritizing remediation of deficiencies that restrict access to premium features, services, or contractual opportunities, and (15) improving predicted outcomes associated with the digital trace, including forecasted revenue, traffic growth, or eligibility thresholds.

The overall health score 116a can also include/be paired with one or more executable plans (or actions) tailored specifically for the business objective or digital trace. For example, should a digital trace’s score for website/domain loading speed be lower than what is necessary to qualify for a user's desired third-party advertiser’s requirements, agent 107 can ensure that overall health score 116 provides or is paired with insight to user 102 for first addressing their website/domain loading speed to align with the desired third-party advertiser's requirements. In some embodiments, agent 107 can initially provide user 102 with relatively simple or low-effort actions designed to produce immediate or incremental improvements to the overall health score 116a. In other embodiments, or as the digital trace progresses, agent 107 can provide more detailed, multi-step, or technically involved actions depending on the business objective, the severity of the deficiency, historical changes to the digital trace, or additional contextual factors determined by agent 107. The executable plans or actions included with the overall health score 116a can thereby guide user 102 through a prioritized and adaptive process for improving both individual scores and the overall health score over time.

FIG. 5 illustrates process 138, which can be an intelligent and automated field of use determination and data gathering process executed by agent 107 operating on server 108a. In process 138, agent 107 can access a digital trace 104b, with input parameter 126d (e.g., a domain or website address). Using the input parameter 126d, agent 107 can programmatically access, retrieve, and analyze multiple categories of data associated with the domain or website address, including data 130a (visible data) and data 130b (non-visible data). Data 130a can be data and/or information obtained from the domain's graphical user interface (GUI), such as pictures, videos, accessible buttons, hyperlinks, icons, graphics, text, etc. Data 130b can include non-visible domain architecture information, such as metadata, configuration files, directory structures, scripts, style sheets, executable code, markup language elements, headers, tags, and other machine-readable components that are not directly rendered to end users. For example, agent 107 may access the source code or other executable instructions that control the functionality or behavior of the domain.

Based on an analysis of data 130a and 130b, agent 107 may then intelligently determine 131 business objectives, additional input parameters, fields of use, and other relevant data associated with the digital trace. These determinations can be used to enable automated selection of repository 110d. For example, if agent 107 accesses the domain (input parameter 126a) and obtains data 130a that includes pictures based on medical topics or text that highlights the domain as a healthcare website, agent 107 could intelligently determine 131 that a healthcare repository 110d should be selected to gather and generate scores. A user will appreciate the intelligent determination 131 capabilities of agent 107, as it can allow for fewer user inputs and refined decision-making by agent 107. By performing automated data extraction, classification, and field of use determination using both visible and non-visible data, process 138 may reduce manual user input, improve consistency in repository selection, and enable agent 107 to generate more contextually relevant scores and actions for the digital trace.

Further, by enabling agent 107 to programmatically analyze both visible data 130a and non-visible data 130b, process 138 can provide for a comprehensive and accurate understanding of a digital trace when compared to systems that rely solely on user-provided inputs or surface-level content analysis. This dual-layer data analysis may increase the reliability of field of use determination and downstream scoring by incorporating functional, structural, and machine-readable characteristics of the digital trace. Additionally, automated access to non-visible domain architecture information allows agent 107 to identify conditions, constraints, or opportunities that are not apparent from a graphical user interface alone, thereby improving the precision of repository selection, score generation, and action planning while reducing manual configuration and user error.

In an example, agent 107 can independently and/or automatically determine 131 that digital trace 104b is associated with a business objective of increasing ad revenue. In such an example, agent 107 may review data 130a and 130b to identify characteristics indicating that digital trace 104b is an online storefront. Agent 107 may also review data 130a and 130b and determine that digital trace 104b lacks advertisements within data 130a and 130b of the digital trace. Agent 107 can then intelligently determine that a repository with a field of use of advertisement is selected, so that a score and a set of actions relating to advertisement regulations and requirements are generated.

In another example, agent 107 may intelligently determine 131 that digital trace 104b is associated with a business objective of improving visibility (e.g., within a search engine), accessibility, or utilization by automated agents, search systems, or large language model-based platforms. In such an embodiment, agent 107 can analyze non-visible data 130b to detect the presence, absence, or configuration of machine-readable resources that influence automated discovery and interpretation, including crawler directives, agent access files (e.g., LLM.txt files), structured data, metadata schemas, and indexing-related configuration files. For example, agent 107 can determine whether files or directives that permit or restrict automated agent access are present, whether such files are properly formatted, or whether they contain incomplete, outdated, or conflicting instructions.

Based on the detected deficiencies or misconfigurations, agent 107 can generate one or more actions for modifying the identified machine-readable resource or human viewable aspect. In at least one embodiment, agent 107 can automatically apply one or more of the generated actions without direct user intervention by programmatically updating, creating, or modifying the relevant files, directives, content, metadata, or configuration settings associated with the digital trace. For example, when authorization credentials, permissions, or configuration settings permit, agent 107 may act without user intervention. In another embodiment, agent 107 can present the generated actions to user 102 for approval prior to or after execution, depending on permission, configuration, or user authorization. Automatic or semi-automatic application of such actions can enable real-time or near-real-time improvement of automated discoverability, indexing accuracy, and interaction readiness of the digital trace.

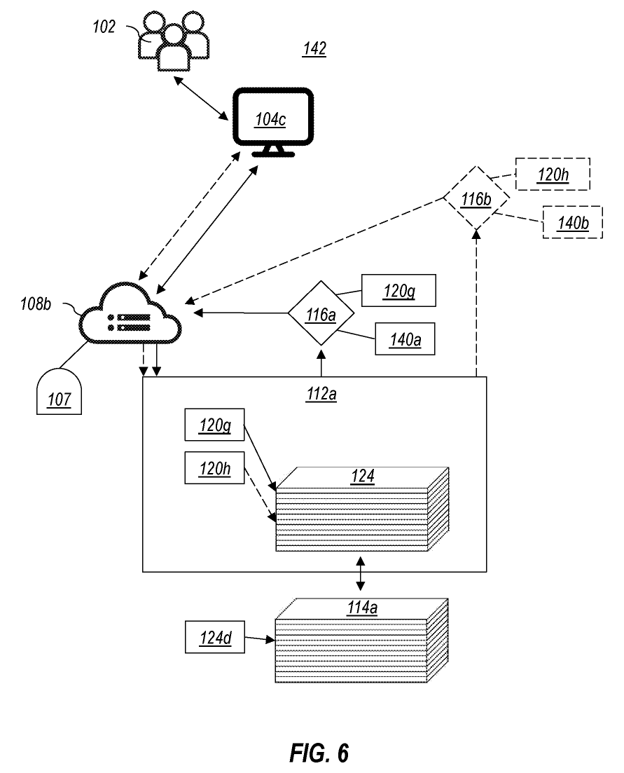

FIG. 6 illustrates feedback loop 142 that can create updated overall health scores. Feedback loop 142 can include a user 102, digital trace 104c, server 108b, agent 107, and process 112a. As shown, using agent 107, the feedback loop includes generating an overall health score of 116a, which may comprise an overall health score, individual score(s) 120g, and action(s) 140a. User 102 can review the overall health score 116a, the individual score 120g, and the action 140a, and can cause action 140a to be executed. Execution of action 140a can be performed by user 102, by digital trace 104c, or automatically by agent 107, depending on permissions, access, or configuration.

Once action 140a is executed, agent 107 can re-access and re-assess digital trace 104c and generate an updated overall health score 116b, an updated individual score of 120h, and a new action 140b. Feedback loop 142 can repeat continuously or periodically and can dynamically adapt to changes in one or more scores or the overall health score of digital trace 104c following execution of each action or after a predetermined time period. Through repeated iterations of score generation, action execution, and re-evaluation, feedback loop 142 can allow agent 107 to incrementally improve the overall health score and individual scores of a digital trace based on the controlling criteria. By anchoring each iteration of score generation and action execution to the applicable controlling criteria, feedback loop 142 can provide that improvements to the digital trace are objective, measurable, and aligned with predefined technical, regulatory, or performance standards.

It can be noted that in the context of feedback loop 142, an individual score of 120g may be defined as a deficient score. A deficient score means that the individual score 120g falls below a corresponding threshold score 124d defined within an associated rubric 114a. Identification of a deficient score can thus trigger the generation of one or more targeted actions 140a by agent 107, specifically selected to address the underlying factors contributing to the deficiency. By formally defining and detecting deficient scores using rubric-based threshold comparisons, agent 107 can prioritize corrective actions, allocate resources efficiently, and systematically guide improvements to the digital trace in accordance with the controlling criteria.

In at least one embodiment, feedback loop 142 can include predictive analysis performed by agent 107. Such predictions can be included in the overall health score 116a and 116b and can indicate to user 102 how the overall health score and individual score are expected to change if the one or more proposed actions are executed. In some embodiments, agent 107 can also predict downstream effects of action execution, including projected improvements across multiple controlling criteria or fields of use. Agent 107 can further predict whether consulting additional repositories may be beneficial for generating further individual scores, identifying additional deficiencies, or accelerating improvement of the digital trace.

For example, predictive analysis can allow agent 107 to identify which proposed action is expected to produce the greatest improvement to the overall health score relative to effort or implementation cost, enabling more efficient optimization of the digital trace. By forecasting downstream effects across multiple controlling criteria or fields of use, agent 107 can reduce potentially unnecessary or redundant actions and guide user 102 or the system toward actions that produce compounding or cascading improvements.

FIG. 6 shows actions 140a and 140b. Actions 140(a-b) can comprise one or more executable steps that user 102, digital trace 104c, or agent 107 can take to modify, correct, or optimize an individual score 120(g-h) or an overall health score 116(a-b). For example, action 140b could include user 102 modifying the codebase of their digital trace 104c to increase performance, such as reducing waiting and loading times or improving crawling or AI-based searching (e.g., adding a file or folder like an LLM.txt file). In another example, action 140b could include a user altering the GUI layout or the words and images presented on the GUI of the digital trace. In yet another example, agent 107, having access to the digital trace, can provide alterations, modifications, and changes as outlined in the specific action 140b.

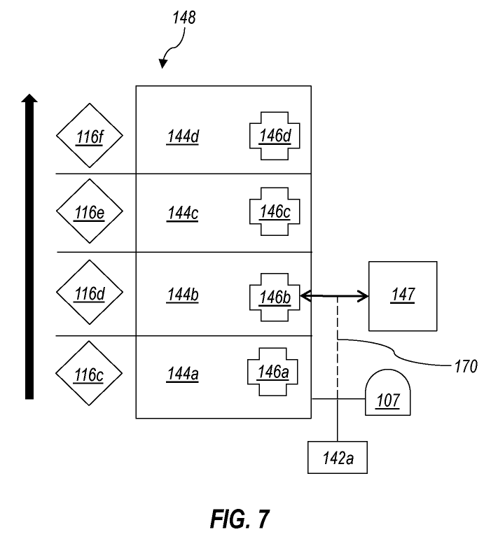

FIG. 7 illustrates a process 148, which can include one or more discrete levels 144(a-d) associated with progressively higher overall health scores. Using feedback loop 142a, agent 107 iteratively modifies, evaluates, and improves a digital trace such that an initial overall health score 116c is increased to overall health score 116d, then to overall health score 116e, and subsequently to overall health score 116f. In at least one embodiment, the modification and alterations may increase the overall health score 116d to become overall health score 116e or 116f.

FIG. 7 illustrates that level 144a is lower than level 144b, which is lower than level 144c, which is lower than level 144d, thereby establishing an ordered progression of health score levels. This progression reflects measurable improvements to the digital trace based on repeated application of controlling criteria, score evaluation, and corrective action. Accordingly, by increasing a user's digital trace's overall health scores, a user can begin to unlock features 146 (or features 146(a-d)) with agent 107. Similarly, if the overall health score of a digital trace decrease, features may be removed until it is once again above a threshold. A decrease in overall health score may occur due to updates in controlling criteria or changes to the digital trace itself. Thus, this feature access (or its unlockable nature) may be conditional on continued compliance, periodic reevaluation, or real-time monitoring.

FIG. 7 shows that each level 144(a-d) can include its own unlockable features, features 146(a-d), that become available upon a digital trace achieving a corresponding overall health score. For example, a digital trace having an overall health score 116d would have access to feature(s) 146d. Feature(s) 146d could be any number of capabilities, accolades, or opportunities, such as, but not limited to, financing plans of action, partnership opportunities, and business growth pathways. Feature 146d can be associated with or provided by a third-party service 147 that can provide such capabilities, accolades, or opportunities. For example, third-party service 147 can be an advertising service. Once the overall health score 116d of the digital trace satisfies the criteria or level 144b required by the third-party service 147, agent 107 can act as a middleman or intermediary to provide intelligent mediation 170 in obtaining the feature 146b for use by the user and their digital trace. Intelligent mediation 170 can include verifying the eligibility of the digital trace based on the overall health score, facilitating secure data exchange, configuring technical integrations, or programmatically enabling access to the feature 146d. In one example, feature 146d can include an advertising-related agreement or service, and agent 107 can facilitate initiation, configuration, enforcement, or ongoing monitoring of the agreement based on continued satisfaction of the applicable health score thresholds. In this manner, access to the features 146 are dynamically gated by objective system-generated scores and maintained through ongoing evaluation of the digital trace.

In some embodiments, the disclosed architecture provides measurable technical improvements to computing system operation. By normalizing heterogeneous digital traces into a unified internal schema prior to rule execution, the system reduces redundant format-specific parsing logic and enables rule evaluation against standardized attribute representations. This normalization reduces processor cycles required for repeated data transformation, decreases memory overhead associated with format-specific evaluation pipelines, and improves throughput when evaluating large volumes of digital traces.

The selective retrieval of controlling criteria based on automatically determined fields of use further improves computational efficiency. Rather than executing all available validation rules against every digital trace, the system restricts rule execution to contextually relevant rule sets. This selective rule activation reduces unnecessary conditional evaluations, minimizes memory access operations, and decreases total execution time for validation routines. In large-scale or multi-tenant deployments, such selective execution enables horizontal scalability and reduces resource contention across distributed computing nodes.

Automated remediation of machine-readable configuration artifacts improves system reliability and configuration consistency. By programmatically modifying configuration files, executable modules, protocol settings, or metadata structures, the system reduces reliance on manual configuration workflows that may introduce human error or configuration drift. Automated validation and re-ingestion following modification further improve operational stability by ensuring that configuration changes produce verifiable improvements in compliance state. In some embodiments, transactional modification and rollback mechanisms improve fault tolerance by preventing persistence of invalid configuration states.

Dynamic association of overall health scores with operational tiers provides a structured mechanism for modifying runtime execution privileges based on measured technical attributes. By mapping score thresholds to predefined execution privilege states, the system enables automatic enforcement of feature-gating logic and access control policies without requiring manual administrative intervention. This tier-based execution control improves reliability of privilege enforcement, reduces misconfiguration risk, and enables real-time adjustment of system capabilities in response to evolving compliance or performance states.

In distributed or cloud-based implementations, the modular repository structure allows independent versioning and updating of machine-readable rule sets without requiring redeployment of core processing logic. This modularity improves maintainability and reduces downtime associated with standards updates. Additionally, decoupling rule repositories from the validation engine enables parallel rule evaluation across multiple processing nodes, further improving scalability and system responsiveness.

In performance optimization embodiments, automated modification of compression settings, cache directives, protocol versions, and load balancing configurations improves measurable performance metrics such as time-to-first-byte, bandwidth utilization, and response latency. In security compliance embodiments, automatic enforcement of cryptographic protocol standards and configuration hardening reduces exposure to known vulnerabilities and improves measurable security posture indicators such as encryption strength, certificate validity compliance, and protocol integrity.

Collectively, these architectural features provide improvements in computational efficiency, rule execution latency, configuration integrity, runtime privilege enforcement accuracy, and distributed system scalability. The disclosed system, therefore, provides practical applications in automated compliance validation, dynamic configuration management, and scalable digital infrastructure optimization through concrete modifications to machine-readable artifacts and execution environments rather than merely generating advisory outputs.

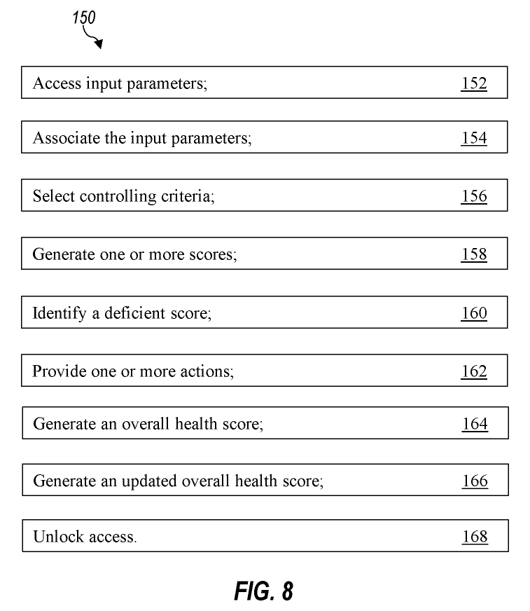

FIG. 8 illustrates method 150 of generating an overall health score of the present disclosure. Method 150 can be implemented within the computing architecture 100 of FIG. 1 and optionally by the agent 107.

Method 150 can comprise act 152, comprising a computer system accessing input parameters. Act 152 can include accessing input parameters associated with one or more digital traces of a user account, the one or more digital traces including at least one network-accessible domain (e.g., domain website information, personal information). Access can be gained through dynamic communication between an agent of the present disclosure and a user. In another embodiment, access can be gained through API creation and usage.

Method 150 can comprise act 154, comprising associating the input parameters. Act 154 can include associating the input parameters of the one or more digital traces with one or more fields of use. For example, a legal webpage can contain data associated with legal topics and themes. This data can be input parameters used in determining the digital trace is a legal webpage. In another example, input parameters can be direct prompts from a user, which can then be associated with one or more fields of use.

Method 150 can comprise act 156 comprising selecting controlling criteria. Act 156 can include selecting controlling criteria from within the one or more repositories associated with the identified one or more fields of use. In at least one embodiment, all controlling criteria in a repository may be used by an agent for a given digital trace. In another embodiment, however, only one or more controlling criteria in a repository may be used by an agent for a given repository.

Method 150 can comprise act 158, comprising generating one or more scores. Act 158 can include generating one or more scores associated with the selected controlling criteria, wherein the one or more scores include a numerical value that corresponds to a relationship between the one or more digital traces and the controlling criteria. The one or more scores can be generated by an agent or gathered/provided from a third-party score providing source.

Method 150 can comprise act 160, comprising identifying a deficient score. Act 160 can include identifying a deficient score within the one or more scores by comparing the one or more scores with corresponding threshold values in a rubric embedded or associated with the controlling criteria and identifying if any of the one or more scores fall below the corresponding threshold values in the rubric. For example, as shown in FIG. 6, a deficient score 120g fell below a corresponding threshold score.

Method 150 can comprise act 162, comprising providing one or more actions. Act 162 can include providing one or more actions for modifying any of the one or more scores that fall below the one or more scores corresponding threshold values in the rubric. The rubric and corresponding threshold value can be retained with each repository, or the rubric can be a separate and distinct entity. An action can be executed by a user, a digital trace, or by an agent of the present disclosure.

Method 150 can comprise act 164, comprising generating the one or more scores and one or more actions. Act 164 can include generating an overall health score by aggregating one or more scores and compiling the one or more actions. In one embodiment, an agent can differentially weigh each score depending on a business objective or an alternative set of criteria.

In some embodiments, compilation of the one or more actions includes generating a structured remediation object stored within a data store and associated with the normalized trace record. The structured remediation object may include an action identifier, an associated deficient score identifier, a severity level, an estimated impact on the overall health score, required execution privileges, dependency relationships with other actions, and an execution status indicator. The system may prioritize the compiled actions according to severity, predicted impact, field-of-use relevance, or business objective weighting. The compiled actions may be stored as a machine-readable data structure that is transmitted to a user interface, exposed through an application programming interface, or passed to a remediation engine for automatic execution.

Method 150 can also comprise act 166, comprising generating an updated overall health score. Act 166 can include generating an updated overall health score after implementation of at least one of the one or more actions on the digital trace. For example, as shown in FIG. 6, an updated overall health score 116b can be generated after applying action 140a.

Method 150 can further comprise act 168, comprising unlocking access. Act 168 can include unlocking access to at least one feature, capability, or third-party opportunity in response to the updated overall health score satisfying a corresponding threshold level. For example, as shown in FIG. 7, features 146a, 146b, 146c, and 146d can be unlocked after a digital trace has improved their digital health score 116.

In some embodiments, a previously restricted computer-implemented function may be restricted through one or more technical enforcement mechanisms, including runtime configuration flags, role-based access control policies, permission tokens, feature-gating logic embedded in executable code, container-level orchestration policies, or access control lists associated with the digital trace. Unlocking access may include programmatically modifying one or more of these enforcement mechanisms by updating configuration parameters, modifying access control tokens, altering runtime execution flags, updating policy enforcement modules, or enabling previously disabled executable modules. For example, an operational tier may be mapped to a specific execution privilege state stored within a machine-readable configuration object. Upon satisfaction of a threshold overall health score, the system may automatically update the configuration object to permit execution of the previously restricted function. In this manner, unlocking access results in a concrete change to system execution privileges rather than merely providing a notification or advisory output.

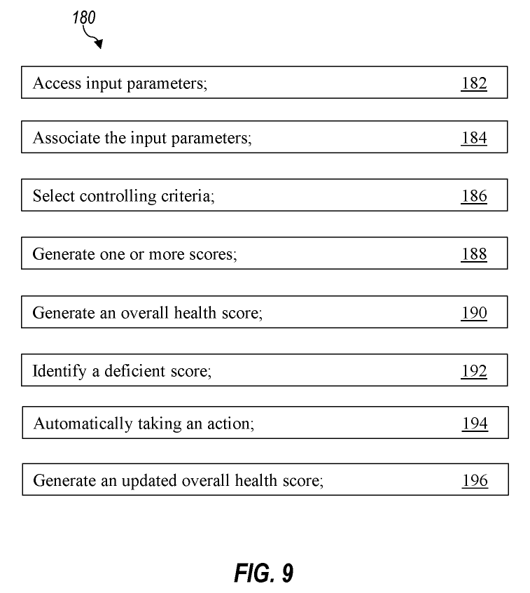

FIG. 9 illustrates a method 180 for increasing an overall health score of a digital trace. Method 180 can comprise act 182 of accessing input parameters. Act 182 can include accessing input parameters associated with one or more digital traces of a user account, the one or more digital traces including at least one network-accessible domain. For example, as shown in FIG. 5, input parameters can be automatically gathered or manually input.

Method 180 can comprise act 184 of associating the input parameters. Act 184 can include associating the input parameters with one or more fields of use determined based on a content or an architecture of the network-accessible domain. For example, as shown in FIG. 5, input parameters can be used to determine a field of use.

Method 180 can also comprise act 186 of selecting controlling criteria. Act 186 can include selecting controlling criteria from within one or more repositories associated with the determined one or more fields of use. For example, as shown in FIG. 3, controlling criteria can be selected based on the determined field of use.

Method 180 can further comprise act 188 of generating one or more scores. Act 188 can include generating a plurality of scores corresponding to the controlling criteria, each score representing a measured technical attribute of the digital trace. For example, as shown in FIG. 4, one or more scores 120 can be generated.

Method 180 can still further comprise act 190 of generating an overall health score. Act 190 can include generating an overall health score containing the plurality of scores, wherein the overall health score is associated with a first operational tier. For example, as shown in FIG. 4, an overall health score 116 can be generated.

Method 180 can also comprise act 192 of identifying a deficient score. Act 192 can include identifying at least one deficient score by comparing the plurality of scores to corresponding threshold values defined in a rubric associated with the controlling criteria. For example, as shown in FIG. 6, a deficient score 120g fell below a corresponding threshold score.

Method 180 can further comprise act 194 of automatically taking an action. Act 194 can include automatically updating, without outside intervention (e.g., user intervention), the content or the architecture of the digital trace in response to the at least one deficient score. For example, agent 107 can automatically apply one or more of the generated actions without direct user intervention by programmatically updating, creating, or modifying the relevant files, directives, metadata, or configuration settings associated with the digital trace.

Method 180 can still further comprise act 196 of generating an updated overall health score. Act 196 can include generating an updated overall health score after the automatic updating of the digital trace, wherein the updated overall health score is associated with a second operational tier. For example, as shown in FIG. 6, an updated overall health score 116b can be generated after applying action 140a.

In some embodiments, the disclosed system comprises a distributed technical architecture configured to ingest, normalize, evaluate, and automatically modify heterogeneous digital traces associated with one or more network-accessible domains or digital accounts. The system may be implemented within a cloud-based computing environment, an enterprise server environment, or a distributed multi-node architecture and may include one or more processors executing instructions stored in non-transitory computer-readable media. The architecture may include a data ingestion module, a normalization engine, a field-of-use determination engine, a rules or standards validation engine, one or more machine-readable compliance repositories, a scoring engine, a remediation engine, and an operational tier control module. These components cooperate to integrate heterogeneous machine-readable artifacts, apply structured rule sets, and modify executable or configuration-level artifacts without requiring manual intervention.

The data ingestion module is configured to retrieve heterogeneous digital traces originating from multiple platforms, protocols, and environments. Such digital traces may include domain name system (DNS) records, web server configuration files, reverse proxy parameters, transport layer security (TLS) certificate metadata, public key infrastructure artifacts, HTTP response headers, structured markup embedded within hypertext documents, executable code modules, application programming interface (API) configuration settings, access control lists, authentication configuration parameters, cookie management settings, container orchestration files, infrastructure-as-code templates, database configuration parameters, log telemetry data, and machine-readable regulatory disclosures. These artifacts may be retrieved through automated crawlers, authenticated API connectors, protocol-level queries, secure shell access, infrastructure orchestration interfaces, or direct configuration inspection mechanisms.

Because digital traces may exist in heterogeneous formats and structures, the normalization engine converts ingested artifacts into a unified internal representation using a normalized data model. In some embodiments, the normalized schema maps heterogeneous source data into structured records comprising a trace identifier, trace type classification, source platform identifier, extracted technical attributes, timestamp metadata, version metadata, associated field-of-use classification, and compliance state indicators. The normalized data model may be implemented using relational database structures, graph-based models, document-oriented storage systems, or hybrid indexed data architectures. By transforming diverse artifacts into a standardized attribute representation, the system enables consistent rule execution across multiple trace types and reduces repeated format-specific evaluation logic, thereby improving computational efficiency and scalability.

The field-of-use determination engine automatically classifies a digital trace into one or more classification states derived from automated analysis of content characteristics or architectural attributes. A field of use is therefore an automatically determined classification state associated with a digital trace, network-accessible domain, or digital account. Classification may be performed using detection of protocol configurations, identification of authentication mechanisms, recognition of payment processing endpoints, identification of data collection interfaces, analysis of API exposure, geolocation indicators, language metadata, or machine-learning-based classification techniques. Once determined, the field of use functions as a computational filter that restricts subsequent evaluation to controlling criteria relevant to the classification state. By selectively loading and executing only rule sets associated with the determined field of use, the system reduces processor utilization, minimizes memory overhead, decreases rule execution time, and improves overall scalability relative to indiscriminate evaluation of all available criteria.

Controlling criteria are stored within one or more machine-readable compliance repositories. As used herein, controlling criteria refer to structured, machine-readable rule sets that define technical validation requirements applicable to one or more fields of use. These rule sets may be encoded as JSON-based schema definitions, XML-based compliance files, executable validation scripts, policy definition language statements, parameterized rule objects, standards-derived rule matrices, or structured validation templates. Each controlling criterion may define a target technical attribute, validation logic, threshold values, severity weightings, dependency relationships, remediation instruction templates, and version metadata. The repositories may be modular, such that distinct repositories exist for security standards, regulatory requirements, accessibility guidelines, performance optimization policies, or platform-specific best practices. Because the rule sets are stored in modular repositories separate from core processing logic, the system enables independent updating, versioning, or expansion of compliance definitions without altering the primary evaluation engine, thereby providing extensibility and adaptability to evolving standards.

The rules or standards validation engine retrieves controlling criteria corresponding to the automatically determined field of use and programmatically evaluates normalized technical attributes against the encoded validation logic. Evaluation may include Boolean condition checks, threshold comparisons, weighted aggregation algorithms, dependency resolution among related rules, and cross-trace correlation analysis. The validation engine generates measured technical attribute scores and deficiency indicators, which are stored in association with the normalized trace records.

In some embodiments, scoring is performed in accordance with a rubric. A rubric refers to an encoded threshold matrix or weighted evaluation structure applied programmatically to measured technical attributes or intermediate scores. The rubric may define threshold ranges mapped to qualitative states, weighted scoring factors, aggregation formulas, compliance state mappings, deficiency severity categorizations, and operational tier transition thresholds. The rubric is implemented as a structured data object executed by one or more processors, such that composite scores and compliance states are derived algorithmically rather than through subjective human assessment.

Upon detection of one or more deficiencies, the remediation engine may automatically modify machine-readable configuration artifacts associated with the network-accessible domain. Automated updating may include modifying TLS protocol settings within server configuration files, removing weak cryptographic cipher suites, injecting or updating HTTP security headers, enabling DNSSEC in DNS zone configuration files, rewriting structured metadata within content templates, modifying API permission scopes, adjusting database configuration parameters, updating container orchestration policies, enabling compression directives, adjusting cache-control headers, or redeploying patched executable modules. These modifications may be performed through authenticated hosting provider APIs, configuration management systems, infrastructure-as-code deployment pipelines, container orchestration interfaces, or secure remote execution channels. Because the system modifies machine-readable artifacts directly, the operational state of the domain is changed at a configuration or execution level rather than merely generating advisory output.

In some embodiments, the system associates a calculated compliance state or overall health score with an operational tier that governs runtime execution privileges. Each operational tier may define execution privilege levels, activation or deactivation of runtime features, API rate limits, permission scopes, integration eligibility, security policy enforcement levels, or orchestration rules. Tiering may be implemented through runtime configuration flags, role-based access control systems, policy enforcement modules, or container-level orchestration policies. When an updated compliance state satisfies required thresholds, the system may automatically modify runtime execution privileges by updating access control tokens, enabling previously restricted service endpoints, expanding permission scopes, removing feature restrictions, or modifying deployment policies. Conversely, degradation of the compliance state may automatically restrict execution privileges. Thus, tier transitions result in concrete technical changes to the execution environment rather than abstract labeling.

In a security compliance embodiment, the system retrieves digital traces including TLS certificate metadata, supported protocol versions, HTTP response headers, DNS records, and server configuration files. The normalization engine extracts measured technical attributes such as certificate expiration dates, key lengths, enabled protocol versions, presence of HTTP Strict Transport Security directives, and DNSSEC configuration states. The field-of-use determination engine identifies the domain as requiring security compliance evaluation based on the detection of authentication interfaces or payment APIs. The validation engine retrieves security-related controlling criteria from a machine-readable repository containing encoded encryption and hardening standards. If deficiencies are detected, the remediation engine may automatically disable deprecated TLS versions by modifying configuration parameters, remove weak cipher suites, inject HSTS headers, enable DNSSEC within DNS zone files, regenerate and deploy updated certificates, or update reverse proxy configuration files. After modification, the system re-ingests the updated configuration and recalculates measured attributes to confirm improved compliance state, thereby strengthening the domain’s technical security posture.

In a regulatory compliance embodiment, the system retrieves structured markup, disclosure metadata, cookie consent configuration parameters, API endpoint definitions, and data retention settings. Automated analysis determines that the domain falls within a particular regulatory field of use based on detected data collection interfaces, jurisdictional indicators, or commerce-related functionality. The rules engine retrieves regulatory controlling criteria encoded within a machine-readable repository defining mandatory disclosures, consent mechanisms, accessibility attributes, and data protection thresholds. Upon detecting non-compliance, the remediation engine may automatically inject required structured disclosure markup into web templates, enable or update cookie consent management scripts, enforce authentication on personal data APIs by modifying configuration parameters, adjust database retention settings, or insert accessibility-related attributes such as ARIA labels. These automated changes modify executable content and configuration artifacts directly, resulting in an updated compliance state and, where applicable, enabling integration with regulated service providers requiring verified technical conformance.

In a performance optimization embodiment, the system retrieves performance-related digital traces, including server response metrics, resource loading sequences, compression settings, cache directives, CDN configuration parameters, and media encoding formats. The normalization engine extracts attributes such as time-to-first-byte, payload size, cache hit ratio, and compression enablement state. Based on detected architectural characteristics, the field-of-use determination engine classifies the domain as performance-sensitive. The validation engine retrieves performance criteria from a repository containing encoded optimization policies and threshold matrices. When performance deficiencies are identified, the remediation engine may automatically enable compression within server configuration files, adjust cache-control headers, deploy updated CDN routing rules, replace large media assets with optimized formats, enable newer HTTP protocol versions, or modify load balancer distribution settings. Following deployment of these changes, updated metrics are measured, and the compliance state is recalculated, thereby improving processing efficiency, network utilization, and response time through direct modification of machine-readable configuration artifacts.

Accordingly, the above passages collectively clarify that digital traces consist of machine-readable technical artifacts, that fields of use are automatically determined computational classification states, that controlling criteria are structured machine-readable rule sets stored in modular repositories, and that rubrics are encoded threshold matrices executed programmatically. The disclosed system therefore operates by automatically evaluating and modifying technical configuration artifacts and runtime execution privileges, providing concrete improvements to security posture, regulatory conformance, performance characteristics, and overall system operation.

FIG. 10 illustrates a computer system 132. As mentioned, computer system 132 can operatively connect with or run server 108b. Additionally, computer system 132 can connect with network 106. Computer system 132 may also communicate with or provide access to agent 107. Computer system 132 can comprise a processor system 134, a storage system 136, and computer-executable instructions 137. Processor system 134 and storage system 136 can be one or more physical hardware devices.

The following discussion is intended to provide a brief, general description of a suitable computing environment in which the present disclosure may be implemented. Although not required, the present disclosure will be described in the general context of computer-executable instructions, such as program modules, being executed by computers in network environments. Generally, program modules include routines, programs, objects, components, data structures, etc., that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the present disclosure may be practiced in network computing environments with many types of computer system configurations, including personal computers, hand-held devices, multi-processor systems, microprocessor-based or programmable consumer electronics, network PCs, minicomputers, mainframe computers, and the like. The present disclosure may also be practiced in distributed computing environments where local and remote processing devices perform tasks and are linked (either by hardwired links, wireless links, or by a combination of hardwired or wireless links) through a communications network. In a distributed computing environment, program modules may be located in both local and remote memory storage devices.

The present disclosure may comprise or utilize a special-purpose or general-purpose computer system that includes computer hardware, such as, for example, a processor and system memory, as discussed in greater detail below. The scope of the present disclosure also includes physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the present disclosure can comprise two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the present disclosure.

Transmission media can include a network and/or data links, which can be used to carry program code in the form of computer-executable instructions or data structures, and which can be accessed by a general-purpose or special-purpose computer system. A “network” is defined as data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module, and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data that, when executed at a processor, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the present disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The present disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the present disclosure may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models, such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment, or cloud-computing platform, may comprise a system that includes a host that is capable of running virtual machines. During operation, virtual machines emulate an operational computing system, supporting an operating system and perhaps other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine interfaces with the appearance (e.g., a virtual resource) of a physical resource. Examples of physical resources include processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A computer system that enables execution of a previously restricted computer-implemented function based on an updated overall health score, said computer system comprising:
one or more processors; and
one or more hardware storage devices that store instructions that are executable by the one or more processors to cause the computer system to:
access input parameters associated with one or more digital traces of a user account, the one or more digital traces including at least one network-accessible domain;
associate the input parameters of the one or more digital traces with one or more fields of use;
select controlling criteria from within one or more repositories associated with the one or more fields of use;
generate one or more scores associated with the selected controlling criteria, wherein the one or more scores include a numerical value that corresponds to a relationship between the one or more digital traces and the controlling criteria;
identify a deficient score within the one or more scores by comparing the one or more scores with corresponding threshold values in a rubric embedded or associated with the controlling criteria and identifying if any of the one or more scores fall below the corresponding threshold values in the rubric;
provide one or more actions for modifying any of the one or more scores that fall below the one or more scores corresponding threshold values in the rubric;
generate an overall health score by aggregating one or more scores and compiling the one or more actions;
generate an updated overall health score after implementation of at least one of the one or more actions on the digital trace; and
unlock access to at least one feature, capability, or third-party opportunity in response to the updated overall health score satisfying a corresponding threshold level, thereby enabling execution of a previously restricted computer-implemented function based on the updated overall health score.

2. The computer system of claim 1, wherein the one or more scores include scores generated by the computer system and scores obtained from one or more third-party sources.

3. The computer system of claim 1, wherein generating the overall health score includes differentially weighing the one or more scores based on a business objective associated with the digital trace.

4. The computer system of claim 1, wherein associating the input parameters with the one or more fields of use includes automatically determining the field of use based on a content or an architecture of the network-accessible domain.

5. The computer system of claim 1, wherein unlocking access includes enabling use of a feature provided by a third-party service.

6. The computer system of claim 5, wherein the third-party service includes an advertising service, financing service, compliance service, or partnership service.

7. The computer system of claim 1, wherein unlocking access includes mediating interaction between the digital trace and a third-party service.

8. The computer system of claim 1, wherein at least one of the one or more actions is executed automatically by the computer system to modify the digital trace without outside intervention.

9. The computer system of claim 8, wherein executing the at least one action includes automatically modifying computer-executable code, configuration files, or content associated with the digital trace.

10. The computer system of claim 1, wherein at least one of the one or more scores represents compliance of the digital trace with at least one of a regulatory, a contractual, or a policy requirement.

11. The computer system of claim 1, wherein at least one of the one or more scores represents at least one of performance, accessibility, security, or visibility of the network-accessible domain.

12. A computer-implemented method for increasing an overall health score of a digital trace and unlocking capabilities and for enabling execution of a previously restricted computer-implemented function based on an updated overall health score, the method comprising:
accessing input parameters associated with one or more digital traces of a user account, the one or more digital traces including at least one network-accessible domain;
associating the input parameters of the one or more digital traces with one or more fields of use;
selecting controlling criteria from within one or more repositories associated with the one or more fields of use;
generating one or more scores associated with the selected controlling criteria, wherein the one or more scores include a numerical value that corresponds to a relationship between the one or more digital traces and the controlling criteria;
identifying a deficient score within the one or more scores by comparing the one or more scores with corresponding threshold values in a rubric embedded or associated with the controlling criteria and identifying if any of the one or more scores fall below the corresponding threshold values in the rubric;
providing one or more actions for modifying any of the one or more scores that fall below the one or more scores corresponding threshold values in the rubric;
generating an overall health score by aggregating the one or more scores and compiling the one or more actions;
generating an updated overall health score after implementation of at least one of the one or more actions on the digital trace; and
unlocking access to at least one feature, capability, or third-party opportunity in response to the updated overall health score satisfying a corresponding threshold level, thereby enabling execution of a previously restricted computer-implemented function based on the updated overall health score.

13. The computer-implemented method of claim 12, wherein associating the input parameters with the one or more fields of use includes automatically determining the field of use based on a content or an architecture of the network-accessible domain.

14. The computer-implemented method of claim 12, wherein the at least one action includes modifying computer-executable code, configuration files, or content associated with the digital trace.

15. The computer-implemented method of claim 12, wherein unlocking access includes enabling a feature on or within the digital trace.

16. A non-transitory computer-readable medium storing instructions that, when executed by one or more processors of a computing system, cause the computing system to execute the method of claim 12.

17. A computer-implemented method for increasing an overall health score of a digital trace, the method comprising:
accessing input parameters associated with one or more digital traces of a user account, the one or more digital traces including at least one network-accessible domain;
associating the input parameters with one or more fields of use determined based on a content or an architecture of the network-accessible domain;
selecting controlling criteria from within one or more repositories associated with the determined one or more fields of use;
generating a plurality of scores corresponding to the controlling criteria, each score representing a measured technical attribute of the digital trace;
generating an overall health score containing the plurality of scores, wherein the overall health score is associated with a first operational tier;
identifying at least one deficient score by comparing the plurality of scores to corresponding threshold values defined in a rubric associated with the controlling criteria;
automatically updating, without user intervention, the content or the architecture of the digital trace in response to the at least one deficient score; and
generating an updated overall health score after the automatic updating of the digital trace, wherein the updated overall health score is associated with a second operational tier.

18. The computer-implemented method of claim 17, wherein automatically updating the content or the architecture of the digital trace includes modifying at least one of a computer-executable code, configuration data, or machine-readable content associated with the digital trace.

19. The computer-implemented method of claim 17, wherein the first operational tier restricts execution of at least one computer-implemented function and the second operational tier enables execution of the at least one computer-implemented function.

20. The computer-implemented method of claim 17, wherein the one or more repositories are organized by regulatory requirements, technical standards, or platform-specific rules associated with the determined field of use.
